(19) United States
(12) Patent Application Publication
(10) Pub. No.: US 2015/0360716 A1
(43) Pub. Date: Dec. 17, 2015

(54) Independent Supplementary Electrically Assisted Power Steering System

(71) Applicant: ROBERT BOSCH AUTOMOTIVE STEERING LLC, Florence, KY (US)

(72) Inventors: Ismail Dagli, Farmington Hills, MI (US); Pierre Abboud, Northville, MI (US)

(73) Assignee: ROBERT BOSCH AUTOMOTIVE STEERING LLC, Florence, KY (US)

(21) Appl. No.: 14/761,454

(22) PCT Filed: Jan. 21, 2014
(86) PCT No.: PCT/US14/12285

§ 371 Date: Jul. 16, 2015

Related U.S. Application Data
(60) Provisional application No. 61/754,701, filed on Jan. 21, 2013.

(51) Int. Cl. B62D 5/04

(52) U.S. Cl. CPC B62D 5/0487; B62D 5/0463; B62D 5/0421

(57) ABSTRACT

The present invention involves a primary electric assist with a secondary fall back steering assist in the case of failures of the primary steering system. The primary and fall back systems can be steering column or steering rack based or any combination of these two options. The secondary steering assist system is a low cost design that ensures the steering torque levels will not exceed predetermined values. The secondary electric steering assist will usually deliver less than 50% of the assistance that is provided by the primary steering assistance system. This level of assistance by the secondary system is sufficient to provide for safe operation of the vehicle.

### CROSS REFERENCE TO RELATED APPLICATIONS

This application claims the benefit of U.S. provisional patent application Ser. No. 61/754,701 filed Jan. 21, 2013.

### BACKGROUND OF THE INVENTION

The present invention relates to an electrically assisted power steering system for motor vehicles. The power steering system contains an input shaft that is in working engagement with a steering wheel and that is used to transfer a torque necessary for steering wheels that are to be steered. An output member is in working engagement with the wheels to be steered. An Electric motor, with which a power assist is exerted on the input shaft or the output member (rack), is arranged on the power steering system. A sensing unit is used to sense the direction and intensity of a steering torque acting on the input shaft, and other steering-specific parameters. An electronics unit is used to process the steering-specific parameters and to control the electric motor.

An electrically assisted power steering system is described, for example, in German Published Patent Application No. 44 07 729. In this power steering system, an electric motor is controlled by an electronic control unit as a function of a torque.

The invention can also be used with a power steering system for a motor vehicle in which a steering rod is held in an axially movable manner. A power steering system of this type is known from DE 103 10 492 A1. The supplementary system can be combined with different primary electrical power assist systems, such as, a column and rack based EPS where the rack based EPS could be based on pinion, dual pinion, coaxial rack and belt drive EPS or any type of engagement system for the primary assist device.

In the electric power steering systems that are currently utilized for vehicles the power assist can be lost suddenly in the case of failures in the steering system. The current electric power steering systems have a multi-layered diagnostics capability that can shut down the system in the case of a failure in the system that can lead to hazardous situations where the inactive assist mechanism is considered as safe state where the passive system must adhere the ECE79 requirements.

The schematics of the steering system must be designed in a way that set levels of steering torque established by the ECE79 standards are not exceeded during the operation of the vehicle. The requirements for retaining the steering torque below certain preset levels can create restrictions on the design of the vehicle that can influence the overall vehicle dynamic performance.

Electric power steering systems have developed concepts to evaluate the information of the assist provided by the electric power steering system. Upon the identification of a difficulty with the system there can be partially redundant paths that can be utilized to avoid an abrupt shut off of the electric power steering system.

The current concepts for diagnostics and redundancy for electric power steering systems are incorporated into a single electric power steering system. There are two main disadvantages with such a system.
Common cause failure modes like water ingress, EMC, physical damage, mechanical failure cannot be considered in such concepts and will eventually lead to loss of steering assist.
The second disadvantage of such redundant systems is that duplicating the main parts of the steering system electronics is a very high cost option. The quality and performance requirements of the steering modules on the primary device require that expensive technology be utilized in the redundant path because it must base on the same technology level.

The present invention is designed to provide an independent secondary steering assist system that avoids the deficiencies of the current electric steering systems. The secondary steering assist is a low cost and simple design that avoids common cause failure issues.

### SUMMARY OF THE INVENTION

The present invention involves a primary electric assist with a secondary fall back steering assist in the case of failures of the primary steering system. The primary and fall back systems can be steering column or steering rack based or any combination of these two options. The secondary steering assist system is a low cost design that ensures the steering torque levels will not exceed predetermined values. The secondary electric steering assist will usually deliver less than 50% of the assistance that is provided by the primary steering assistance system. This level of assistance by the secondary system is sufficient to provide for safe and comfortable operation of the vehicle. The secondary assist system may only be functional for a predetermined period of time to allow the driver of the vehicle to take appropriate action to address the failure in the primary electric steering assist The secondary steering assist system is at least partially separate from the primary electric steering assist system to avoid common cause failures that can compromise the entire electric steering systems.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a schematic of an electrically assisted power steering system.

FIG. 2 is a side elevation view of a steering system.

FIG. 3 is a cross sectional view of a portion of the steering system of FIG. 2.

FIG. 4 is a perspective view of the steering system of the present invention.

FIG. 5 is a side elevation view of a portion of the steering system of FIG. 4.

FIG. 6 is a partial cross sectional view of the steering system of FIG. 5.

FIG. 7 is a perspective view of an example of a stiff and low cost sensor.

### DETAILED DESCRIPTION OF THE PREFERRED EMBODIMENT(S)

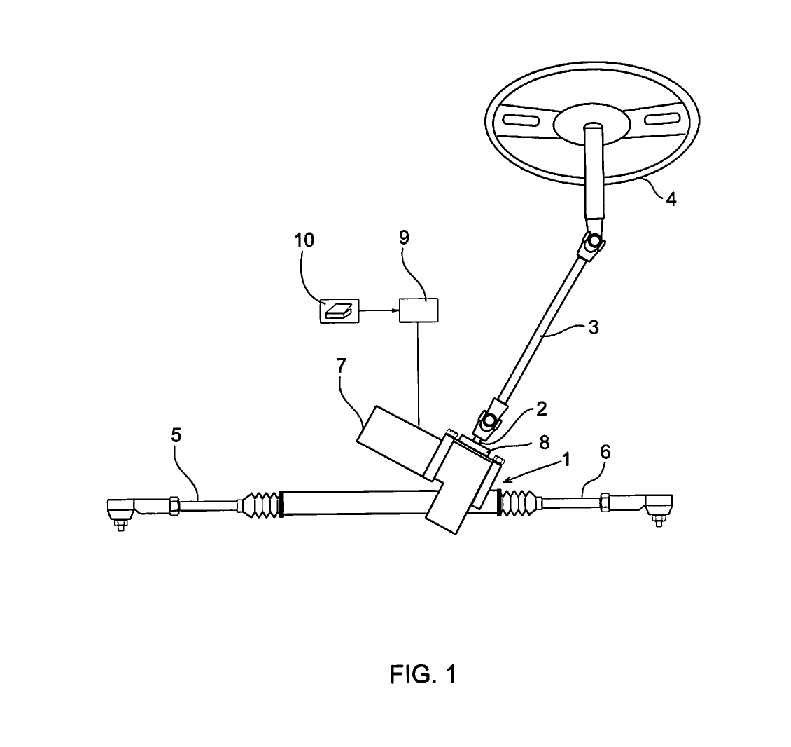

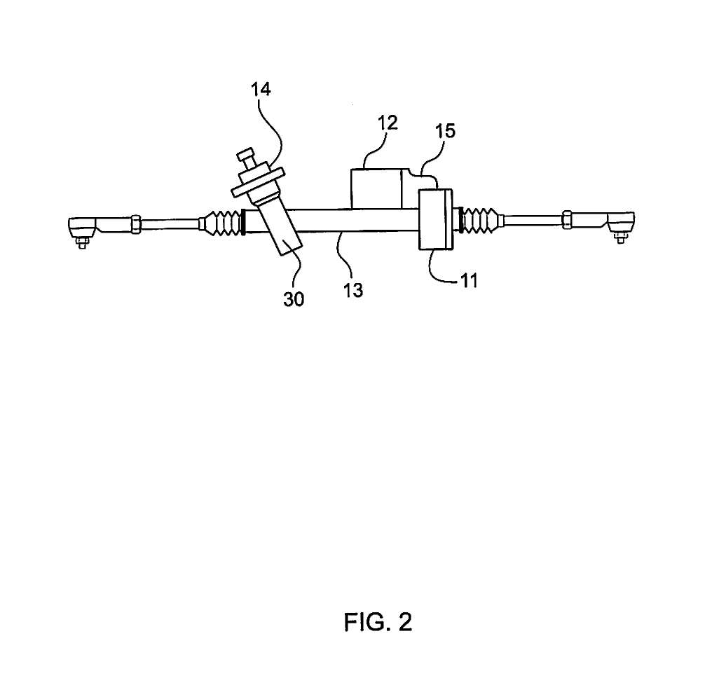

As mentioned above the supplementary Electrical Power Assist System can be combined with any currently available primary steering assist system. For the better understandability of the concept and to simplify the functional description of the supplementary system there are two basic schematics shown FIG. 1 and FIG. 2. that describe well know designs for belt drive and pinion based Electrical Power Assist Systems.

As illustrated in FIG. 1 the electrically assisted power steering system contains a steering gear in the form of a rack-and-pinion steering system 1. The rack-and-pinion steering system is conventionally known, and will therefore not be described further. A pinion (not depicted) of the rack-and-pinion steering system carries an input shaft 2 that, for example, by way of a steering column 3 equipped with universal joints, is in working engagement with a steering wheel 4. A different steering gear, for example, a recirculating-ball steering system, may also be used instead of a rack-and-pinion steering system.

A toothed rack (not depicted) of rack-and-pinion steering system 1 forms, together with two steering draft links 5 and 6, an output member that is in working engagement with wheels (not depicted) that are to be steered. The toothed rack constitutes the output element of the steering system.

With a power steering system of this kind, a steering torque may be transferred from steering wheel 4 to the wheels that are to be steered.

A power assist may be exerted onto input shaft 2 by an electric motor 7. In the exemplary embodiment shown in FIG. 1, electric motor 7 is arranged so that its axis is perpendicular to the axis of input shaft 2 and thus to the axis of the pinion. Its axis may also be a different angle to the axis of the input shaft, for example, at an angle of from 60° to 130°.

With the same or similar effect, electric motor 7 may be arranged so that its axis is arranged parallel to the axis of input shaft 2 and thus to the axis of the pinion or another part of steering column 3.

In the two types of arrangement of electric motor 7 described above, the latter acts on input shaft 2 and on the pinion of rack-and-pinion steering system 1. Electric motor 7 may also be arranged so that is axis runs parallel or at an angle to, or coaxially with, the axis of the toothed rack of rack-and-pinion steering system 1.

A sensing unit 8 is used to sense the direction and intensity of a steering torque acting on input shaft 2 and other steering-specific parameters. In the exemplary embodiment, sensing unit 8 is arranged on input shaft 2. Sensor unit 8 may also, however, be provided elsewhere in the steering system.

An electronics unit 9 is used to process the steering-specific parameters and to control electric motor 7.

According to the present invention, a detection unit 10 is provided, serving to ascertain the parameters for the equipment variant of the vehicle present in each case. These ascertained parameters are conveyed to electronics unit 9 for adapted control of electric motor 7. The steering characteristic curve can thereby be adapted to the corresponding vehicle equipment variant. It is possible in this fashion, solely by way of the control algorithm established in the software of electronics unit 9, to generate a steering characteristic profile that corresponds exactly to the “nominal” characteristic curve.

Advantageously, the parameters for the equipment variant of the vehicle present in each case include values for the specific front axle load of the vehicle, by way of which, for example, different engine variants may be taken into consideration.

In order to take into account different tire types that may be mounted on one particular vehicle during the course of the vehicle's service life, the values for the tire characteristic are sensed. These values may include, for example, information, relating to tire slip stiffness, force/deformation behavior, and/or parameters for specific tire types. In this context, several different tire versions, the most important driving characteristics of which are comparable may be combined into characteristics groups.

The parameters for the equipment variant of the vehicle present in each case may be read into the detection unit, for example, in accordance with a barcode identifier. In this context, for example, different barcode identifiers are associated with different engine variants or tire types.

Detection unit 10 may be integrated, at the vehicle manufacturer's premises, into an end-of-line computer (assembly line programming unit), into service location shop testers, or, in special cases, into electronics unit 9. The parameters can then be read into electronics unit 9 via a vehicle interface provided for that purpose.

Multiple steering characteristics may be read into electronics unit 9. The particular characteristic that is appropriate may be activated in accordance with the parameters for the equipment variant of the vehicle present in each case.

Power steering systems for motor vehicles are sufficiently known from the general prior art, and here reference is made, for example to DE 103 10 492 A1, so that hereafter only the characteristics that are essential for the invention will be addressed in more detail.

FIG. 2 shows a power steering system for motor vehicles, comprising a housing 11, an electric motor 12, and a steering rod 13 for moving vehicle wheels, which is not shown in detail. Moreover, the power steering system comprises a pinion 30 having a torque sensor 14 and a gear unit 15, by means of which the steering rod 13 is drivingly connected to an output shaft 6 of the electric motor 12, the output shaft 16 not being shown in detail in FIG. 2.

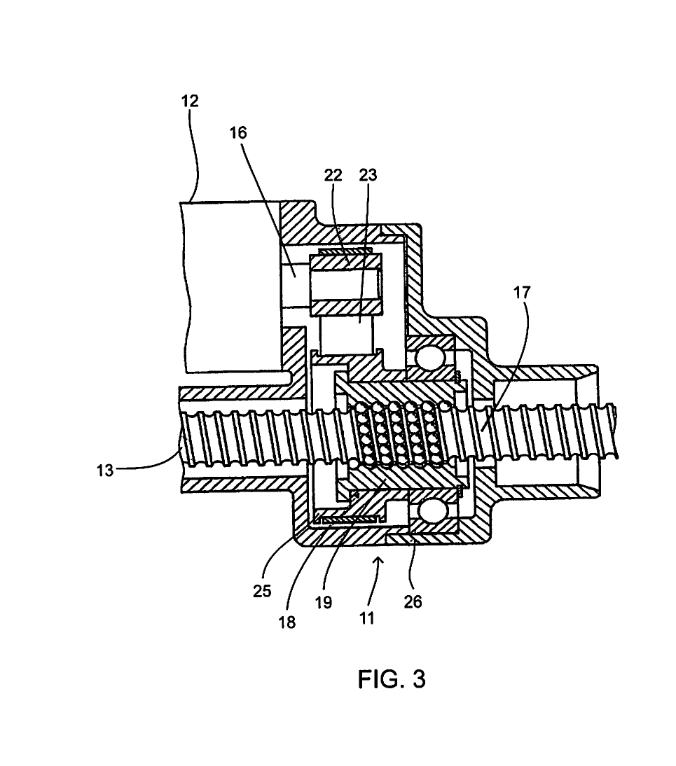

As is apparent from FIG. 3 the steering rod 13 is disposed parallel to the electric motor 12. On a teeth meshing section, which is not shown in FIG. 2, the steering rod 13 meshes with a pinion 30 of a steering rod, the pinion likewise not being shown out, in detail, and comprises an external thread on a spindle section 17. The spindle section 17 of the steering rod 13 is part of a recirculating ball screw and nut gear 18.

The spindle section 17 engages with a recirculating ball nut 19, which is also part of the recirculating ball screw and nut gear 18. The recirculating ball nut 19 is mounted in an axially fixed manner and forms a leading screw together with the steering rod 13. The recirculating ball nut 19 is non-rotatably connected to a driven disk 25 and mounted in the housing 11 by way of a bearing 26. Other types of gear drive systems, such as a worm and worm wheel can be substituted for the recirculating ball nut drive.

A driving disk 22 is fixed on the output shaft 16 of the electric motor 12. A traction means designed as a belt 23 is tensioned over the driven disk 25 and the driving disk 22 and, together with these disks, forms a traction drive. A force is transmitted from the electric motor 12 to the recirculating ball nut 19 via the traction drive.

The electric steering concepts previously disclosed are very effective at applying power assist to the steering inputs made by the driver to the steering wheel of a vehicle. The power assist allows the driver to more easily place the steered wheels of the vehicle in a desired location. There is always, however, the possibility that the electric motor that provides the assist for the steering effort by the driver can experience a difficulty that will result in the inability of the electric motor to provide the anticipated assistance. When there is a failure in the electric steering system this failure can happen in very quick fashion and the assistance provided by the electric motor will no longer be available to the driver of the vehicle. The loss of the assistance by the electric motor can result in a significant increase in the effort required to turn the steering wheel to position the wheels of the vehicle in a desired location. Such a loss of the power assist from the electric motor can be very disruptive to the ability of the driver to provide steering input for the vehicle. As this change can happen very quickly the driver may not have any warning that the effort required to steer the vehicle has appreciatively changed. The increase in the steering effort can result in conditions that compromise the operation of the vehicle. Although such failures of the electrical assistance system for the steering of a vehicle are extremely rare, there is still a need in the automotive industry for an electrical steering system that provides backup power assistance in the unlikely event of a failure of the primary electrical power steering assistance system.

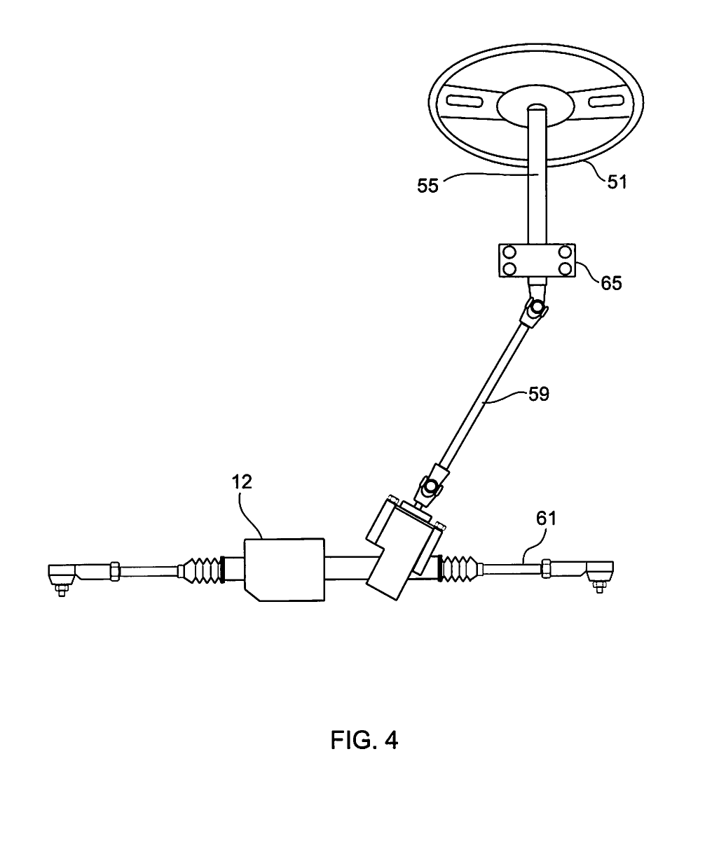

The present invention is directed to a secondary power assistance system that is available to provide a level of power assistance for the steering wheel and steering column that will allow the driver to safely steer the vehicle upon the failure of the primary electric steering assistance system. As shown in FIG. 4 there is a steering wheel 51 attached to a steering column 55. The steering column is attached to intermediate shaft 59 and the intermediate shaft is connected to the steering rack 61. The steering rack functions in the manner previously described and has ends that are connected to the steered wheels of the vehicle. The rotation of the steering wheel 51 is transferred through the steering column 55 in the intermediate shaft 59 to the steering rack 61. The rotational movement of the steering wheel is transferred into lateral motion on the steering rack 61 in a manner that is well known in the art.

An electrical motor 7, 12 can be utilized to provide a power assist to reduce the effort that the driver of the vehicle must input to the steering wheel 51 to change the orientation of the steered wheels that are connected to the steering rack 61. The electric motor 12 can be attached to the steering column 55 in the manner previously described in this patent application. The electric motor 7 can be attached to the steering rack 61 in the manner previously described in this patent application. The position of the electric motor is a matter of design choice and it can be positioned in either location and still function with the device of the present invention. The power assist that is provided by the electric motor has all of the advantages that have been well known in the automotive industry for many years.

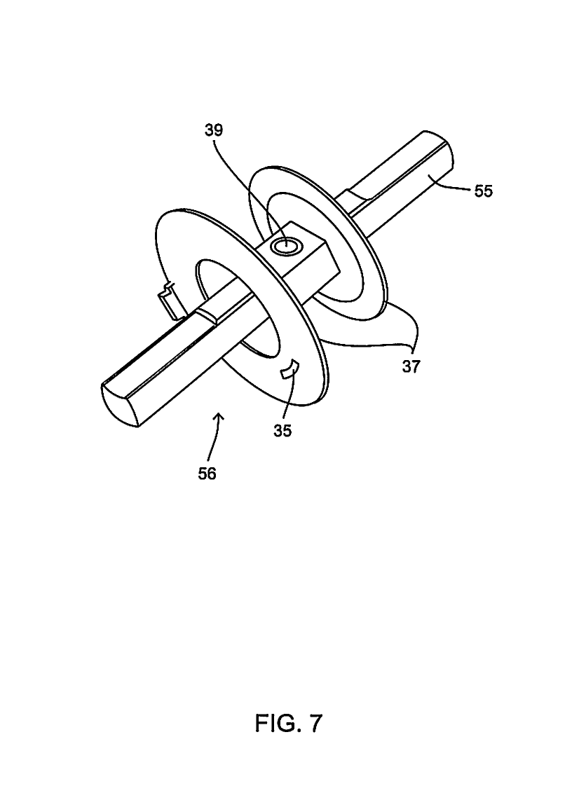

The secondary power assist device 65 of the present invention is designed to provide a level of power assist to reduce the steering effort necessary to steer the vehicle in a safe manner. The device 65 is designed to be activated and engaged only when there is a failure in the primary electrical assist system that is used with the vehicle. In today's computer controlled vehicles a monitoring system can be attached to the primary electrical assist system to produce a signal if the primary electrical assist system is not functioning or has a significant reduction in the assist that is provided by the primary system. It is also possible to provide a sensor 56 that is attached to the steering column 55 that monitors the level of torque required to rotate the steering column. If the sensor determines that the level of torque has exceeded a predetermined value this will be an indication that the primary electrical assist system for the steering of the vehicle has reached a failure point where the level of torque required to change the direction of the steered wheels is unacceptably high. If such a sensing unit is utilized the design can account for characteristics like stiffness and friction where steering feel is a concern. An example of such a sensing unit 56 is shown in FIG. 7. The sensing unit measures amplitude and frequency to measure the torsion in the system and to calculate the applied torque. Such sensing units are commercially available from suppliers such as Golledge, Allied Electronics and Honeywell. The sensing unit usually includes an excitation and evaluation unit 35, wireless signal couplers 37 and a surface acoustic way sensor 39. This sensing unit is based on ultra-sonic measurement and has much higher stiffness than the components of the steering column 55 and intermediate shaft 59 so that the influence on the overall stiffness of the system is negligible. It should be noted that there are other options that can be utilized to determine when there is a failure or a malfunction in the primary electrical assist provided to the steering column of the vehicle. It should be recognized that any of these additional systems could be utilized to determine that there is a problem with the primary electrical assist system and that there is a need for secondary electrical assist to reduce the steering effort necessary to control the vehicle to an acceptable level.

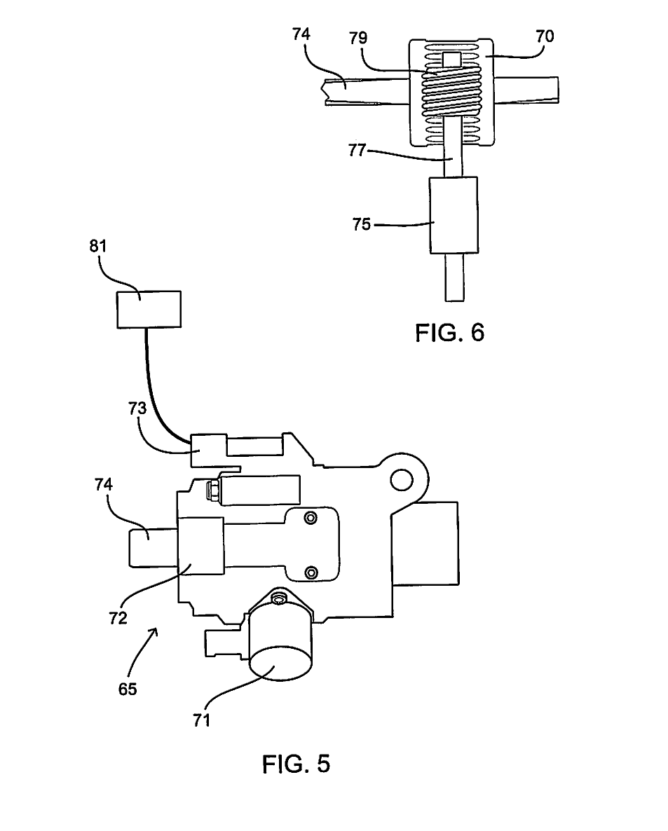

The secondary power assist device 65 is shown in FIGS. 5 and 6 as being positioned on the steering column 55 and the primary electrical assist motor 7, 12 being positioned on the steering rack 61. As discussed previously, however, it should be recognized that the positioning of the primary and secondary electrical power assist devices can be either the steering column or the steering rack without impacting the operation of either device. The secondary power assist device has a locking or engagement unit 71 that locks angle gear 70 to the steering column 55. The locking unit 71 is caused to be engaged by a signal sent to connector 72. The signal is provided from one of the monitoring systems previously described that determines that the primary electrical assist system is not operating at an acceptable level of assist. When this signal is received by the connector 72 a signal is sent to the locking unit 71 to engage the gear 70 with the steering shaft 74 located in the steering column 55. A secondary electric motor 75 has an output shaft 77 and a worm gear 79 is mounted on the end of the output shaft that extends from the electric motor 75. The worm gear is disposed to engage the gear 70 located on the steering shaft 74. A power source 81 is operatively connected to the secondary electric motor 75. The power source 81 is connected to provide power to the secondary electric motor. The secondary power assist electric motor is only operational when a signal has been received by the secondary power assist device that the primary electric motor assist is not functioning at an acceptable level. The power source can be a battery, a capacitor, or other source of electrical energy that is suitable to operate the secondary electrical motor 75 to provide an acceptable secondary level of power assist to the steering system for the vehicle. The power source 81 can also be designed to provide the power to the secondary electrical motor only for a period of time that is sufficient to allow the driver of the vehicle to deal with the reduction in electrical assist provided by the primary electrical motor. For failure modes where the car battery supply is still available a limp home type service is more likely. In other cases, in failure modes where the car battery supply is not available a supplementary but inbuilt energy source can be designed such as battery packs or capacitors.

The signal that is supplied to the connector 72 can also be utilized to send a signal to the primary electrical power assist system to disengage the primary electrical motor 7, 12 from engagement with the steering column 55 or steering rack 61. Thus, the signal can be used to effectively remove the primary electric motor from being operatively connected to the steering system. By disconnecting the primary electrical motor from the steering system the effort required to turn the steering wheel to change the position of the steered wheels will not need to overcome any resistance provided by the primary electrical motor.

The secondary power assist device is designed to provide approximately less than one half of the level of assist that is provided by the primary electric motor 7, 12. It has been found that this level of power assist will be effective at allowing the driver to have enough power assist to easily operate the vehicle in a safe manner. In fact, it has been found in practice that the secondary electric motor can provide a level of assist to the steering system that is from about 25% and to about 15% of the level of assist provided by the primary electric motor 7, 12 without significantly compromising the ability of the driver to control the steering of the vehicle. The reduce of power assist provided by the secondary electric motor 75 does, however, warn the driver that there has been a failure in the primary electric power assist system for the steering of the vehicle. This allows the driver to take appropriate measures to make sure that the vehicle is operated in a safe manner.

The power source 81 that is utilized to operate the secondary electric motor 75 is designed to provide electrical energy to the secondary electric motor for a predetermined period of time. Usually the battery, capacitor or other device that is utilized to provide power to the secondary electric motor will only have enough energy to operate the secondary electric motor for a period of time. The secondary electric motor and the power source 81 are not usually designed to be a replacement for the primary electric assist provided for the steering system of the vehicle. Instead the power source 81 and secondary electric motor 75 are designed to allow the steering system to be used at a reduced level of assistance to provide a warning to the driver that there is a problem with the electrical steering assist system and to give the driver sufficient time to take appropriate action to safely operate the vehicle under the changed conditions.

The secondary power assist device 65 of the present invention can be designed to work in cooperation with the primary electric motors 7, 12. In this arrangement the output shaft 77 connected to the secondary electric motor 75. A connector 73 is provided on the secondary power assist device and the connector 73 is operatively connected to the ECU for the vehicle. The primary and secondary assist can be controlled in a way that they cooperate to provide the desired assist level. The control can also realize an engagement and disengagement strategy with engagement clutches in such that either the primary steering is disengaged in case of a failure to reduce required torques of the secondary system or to engage the secondary system in case of a failure if continuous engagement is a concern with regards to friction and inertia.

As an example, when the ECU determines that the primary electrical power assist system is not providing an adequate level of assist, the ECU would send a signal to the connector 73. The power source 81 that is used to operate the secondary electric motor 75 is designed to be maintained at its maximum output during the normal operation of the vehicle. The power source 81 can be designed so that it can provide energy to the secondary electric motor 75 separately from the other power systems of the vehicle. As an example, the use of a battery or a capacitor as the power source 81 would allow for the storage of electrical energy that could be utilized to operate the secondary electric motor 75 when necessary. A failure of the main electrical system of the vehicle would not result in a failure of the battery or capacitor that is functioning as the power source 81. This provides an effective backup power steering assist system that is not impacted by the failure of other systems in the vehicle.

A design example for the supplementary system is shown in the Table 1.

Design Example Supplementary System

| | | | |
|---|---|---|---|
| System requirements | Minimal limp aside time | 3 | s |
| | Minimal limp aside assist | 1 | kN |
| Motor sizing | Torque | 0.6 | Nm |
| | Max RPM | 1000 | rpm |
| | Power | 62.8 | W |
| | Efficiency | 40% | |
| | Voltage | 12 | V |
| Power stage sizing | Strom: | 13.1 | A |
| Gear sizing | Ratio | 20 | |
| Energy storage sizing | Energy | 471.2 | Ws |
| | Akku-Ladung: | 10.9 | mAh |
| | Voltage drop: | 2 | V |
| | Capacity: | 235.6 | mH |

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A steering system for controlling the wheels on at least one end of a vehicle comprising:
a steering column;
a steering rack connected to the wheels on at least one end of the vehicle;
a first steering assist motor for assisting in transferring a motion from the steering column to the steering rack to control the position of the wheels to a desired position;
a sensor for determining a failure in the first steering assist motor; and
a second steering assist motor for assisting in transferring motion from the steering column to the steering rack, the second steering assist motor being separately activated by the sensor upon a failure of the first steering assist motor, the second steering assist motor providing less than % of the steering assistance of the first steering assistance motor.

2. The system of claim 1 wherein the second steering assist motor is an electric motor.

3. the system of claim 2 wherein the second steering assist motor is operatively attached to a steering column that connects the steering wheel to the steering rack.

4. The system of claim 2 wherein the second steering assist motor is operatively attached to the steering rack.

5. The system of claim 1 wherein a monitoring system is operatively connected to the sensor, the monitoring system providing a signal when the sensor determines that the first steering assist motor is not functioning properly.

6. The system of claim 1 wherein the sensor is an ultra-sonic measuring device.

7. The system of claim 1 wherein a power source provides power to the second steering assist motor.

8. The system of claim 7 wherein the power source is a battery or a capacitor.

9. The system of claim 5 wherein the signal activates a locking unit to operatively connect the second steering assist motor with the steering column.

10. The system of claim 1 wherein the second steering assist motor provides from about 15% to about 25% of the steering assist provided by the first steering assist motor.

11. The system of claim 9 wherein the second steering assist motor is operatively connected to the first steering assist motor.
